(19) United States
(12) Patent Application Publication
(10) Pub. No.: US 2023/0134624 A1
(43) Pub. Date: May 4, 2023

(54) TORQUE CONVERTER WITH MULTI-PLATE CLUTCH ASSEMBLY

(71) Applicant: Schaeffler Technologies AG & Co. KG, Herzogenaurach (DE)

(72) Inventors: Raymundo Juan Lien Chang, Amozoc (MX); Alfredo Perez Mitre Jimenez, Wooster, OH (US); Omar Yair Guerra, Puebla (MX)

(73) Assignee: Schaeffler Technologies AG & Co. KG, Herzogenaurach (DE)

(21) Appl. No.: 17/964,992

(22) Filed: Oct. 13, 2022

Related U.S. Application Data
(60) Provisional application No. 63/274,249, filed on Nov. 1, 2021.

(51) Int. Cl. F16H 45/02

(52) U.S. Cl. CPC F16H 45/02; F16H 2045/0278; F16H 2045/0221

(57) ABSTRACT

A torque converter includes a front cover arranged to receive a torque and an impeller having an impeller shell non-rotatably connected to the front cover. A turbine is fluidly coupled to the impeller and includes a turbine shell. A lock-up clutch is provided that includes a piston configured to axially displace to engage and disengage the lock-up clutch; a first clutch plate and a second clutch plate connected to each other, the first and second clutch plates being disposed between the piston and front cover; and a flexible clutch plate disposed axially between the first and the second clutch plates and connected to the piston.

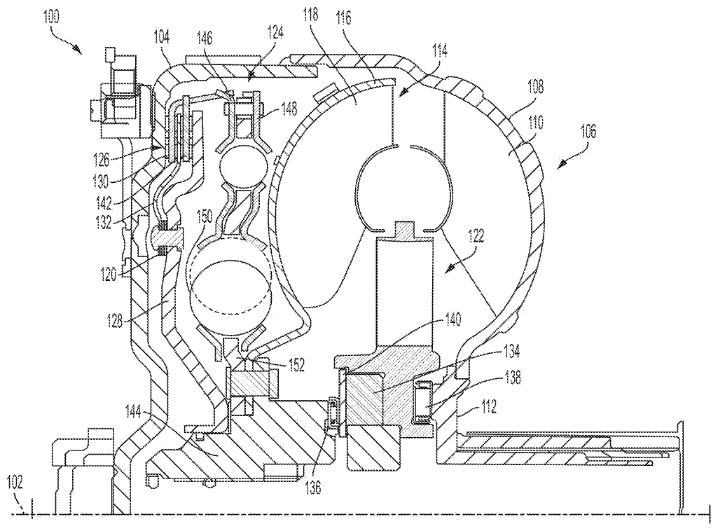

### CROSS-REFERENCE TO RELATED APPLICATIONS

This application claims the benefit of U.S. Provisional Patent Application No. 63/274,249, filed Nov. 1, 2021, the disclosure of which is incorporated in its entirety by reference herein.

### TECHNICAL FIELD

The present disclosure relates to a torque converter for a vehicle. In particular, the disclosure is related to a multi-plate clutch assembly of a torque converter.

### BACKGROUND

Many vehicles include a launch device between the engine and the transmission. A torque converter is a type of launch device commonly used in vehicles having an automatic transmission. A typical torque converter includes an impeller fixed to the crankshaft of the engine and a turbine fixed to a turbine shaft, which is the input to the transmission. To improve fuel economy, most torque converters include a bypass or lock-up clutch that mechanically couples the turbine shaft to a cover of the torque converter to bypass the fluid coupling. In some arrangements, the lock-up clutch may have a clutch plate riveted to a front cover of the torque converter. Due to limited spacing within a torque converter envelope, it is desirable to have alternative designs and configurations to fit all the necessary components within the torque converter while still meeting durability and performance requirements.

### SUMMARY

In one embodiment, a torque converter comprises a front cover configured to receive a torque and an impeller having an impeller shell non-rotatably connected to the front cover. A turbine is fluidly coupled to the impeller and includes a turbine shell. A lock-up clutch is provided that includes a piston configured to axially displace to engage and disengage the lock-up clutch; a first clutch plate and a second clutch plate connected to each other, the first and second clutch plates being disposed between the piston and front cover; and a flexible clutch plate disposed axially between the first and the second clutch plates and connected to the piston.

In embodiments, the torque converter may further include a leaf spring connected to the piston radially inside of the first and second clutch plates. The intermediate clutch plate may be connected to the leaf spring at a radially inner end thereof. The leaf spring may be, at least partially, disposed axially between the piston and the intermediate clutch plate. The intermediate clutch plate, the leaf spring, and the piston may be connected to each other via a riveted connection.

In embodiments, the intermediate clutch plate may be connected to the piston radially inside of the first and second clutch plates. In embodiments, the intermediate clutch plate may be connected to the piston at a radially inner end thereof. In embodiments, the first clutch plate may be connected to the second clutch plate radially outside of the intermediate clutch. In embodiments, the first clutch plate may be connected to the second clutch plate radially outside of the piston. In embodiments, the intermediate clutch may be configured to bend relative to the piston during operation of the lock-up clutch.

In embodiments, the torque converter may further include a damper assembly having an output flange and a cover plate disposed axially between the piston and the output flange. The first clutch plate may be connected to the cover plate.

Embodiments of this disclosure further provide a lock-up clutch for a torque converter. The lock-up clutch includes a piston configured to axially displace to engage and disengage the lock-up clutch; a first clutch plate and a second clutch plate connected to each other; and a flexible clutch plate disposed between the first and the second clutch plates and connected to the piston.

In embodiments, the lock-up clutch may further include a leaf spring connected to the piston radially inside of the first and second clutch plates. The intermediate clutch plate may be connected to the leaf spring at a radially inner end thereof. The leaf spring may be, at least partially, disposed axially between the piston and the intermediate clutch plate. The intermediate clutch plate, the leaf spring, and the piston may be connected to each other via a riveted connection.

In embodiments, the intermediate clutch plate may be connected to the piston radially inside of the first and second clutch plates. In embodiments, the intermediate clutch plate may be connected to the piston at a radially inner end thereof. In embodiments, the first clutch plate may be connected to the second clutch plate radially outside of the intermediate clutch. In embodiments, the first clutch plate may be connected to the second clutch plate radially outside of the piston.

### BRIEF DESCRIPTION OF THE DRAWINGS

The single FIGURE is a cross-sectional view of a torque converter having a multi-plate clutch assembly according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In some torque converter arrangements, it may be challenging and difficult to connect and center a second outer clutch plate of a multi-plate lock-up clutch assembly to the torque converter due to limited packaging and space constraints. Additionally, because of the multi-plate design, it is required that all clutch plates have relative motion where required to generate the required friction. Embodiments described herein provide a multi-plate clutch assembly with a flexible, intermediate clutch plate attached directly to a leaf spring package and a piston of a torque converter. Embodiments according to the present disclosure provide several advantages including providing a multi-plate clutch assembly for torque converters with space constraints as described above.

Referring to the single FIGURE, a portion of torque converter 100 is illustrated according to one embodiment of the present disclosure. At least some portions of torque converter 100 are rotatable about central axis 102. While only a portion above central axis 102 is shown in the single FIGURE, it should be understood that the torque converter can appear substantially similar below central axis 102 with many components extending about central axis 102. Words such as “axial,” “radial,” “circumferential,” “outward,” etc. as used herein are intended to be with respect to central axis 102.

Torque converter 100 includes: front cover 104 arranged to receive torque; impeller 106; turbine 114; and a lock-up clutch 126. Impeller 106 includes: impeller shell 108 non-rotatably connected to front cover 104 such that impeller 106 rotates as front cover 104 rotates, at least one impeller blade 110 attached to an inner surface of impeller shell 108, and impeller hub 112 attached to a radially inner end of impeller shell 108. Turbine 114 includes turbine shell 116 and at least one turbine blade 118 attached thereto. Turbine shell 116 may be connected to output hub 144 for torque transmission therebetween. By “non-rotatably connected” components, we mean that: the components are connected so that whenever one of the components rotate, all the components rotate; and relative rotation between the components is not possible. Radial and/or axial movement of non-rotatably connected components with respect to each other is possible, but not required.

Torque converter 100 may include: stator 122 disposed axially between impeller 106 and turbine 114 to redirect fluid flowing from turbine blade 118 before fluid reaches impeller 106 to increase an efficiency of torque converter 100. For example, impeller blade 110 when rotated about central axis 102, pushes the fluid outwardly. The fluid pushes against turbine 114 of torque converter 100, causing turbine 114 to revolve about central axis 102. Stator 122 functions to return the fluid from turbine 114 back to impeller 106 with minimal or no power loss. Drive power is transmitted from turbine 114 to an input shaft of the transmission (not shown). Torque converter 100 may further include: one-way clutch 134 disposed within stator 122, thrust bearing 136 disposed axially between stator 122 and turbine shell 116 and thrust bearing 138 disposed axially between stator 122 and impeller shell 108, and side plate 140 configured to retain the one-way clutch 134 within the stator 122.

Torque converter 100 also includes damper assembly 124 for hydraulically transferring torque through torque converter 100. Damper assembly 124 is positioned axially between front cover 104 and turbine 114 and may be configured to transfer torque from front cover 104 to output hub 144. Damper assembly 124 may include input cover plate 146, input cover plate 148, springs 150, and output flange 152. Input cover plate 146 may support springs 150 on one axial side. Input cover plate 148 may support springs 150 on another, opposite axial side. Output flange 152 may be connected to output hub 144 for torque transmission therebetween. Output flange 152 may be connected to turbine shell 116, e.g., via a connector such as a rivet.

Power from a vehicle engine (not shown) can be transmitted to a transmission via fluid, and via the torque converter. In particular, the power may first be transmitted to front cover 104 of torque converter 100. Lock-up clutch 126 is configured to selectively transfer torque from front cover 104 to output hub 144. Lock-up clutch 126 includes piston 128, clutch plate 130, clutch plate 132, and clutch plate 142.

Clutch plate 130 and clutch plate 142 may be connected to one another (e.g., via a tabbed connection) and act as outer clutch plates, with clutch plate 130 directly connected to an input of damper assembly 124. For example, clutch plate 130 may be drivingly connected to input cover plate 146 to transfer torque thereto, e.g., via a tabbed connection. Clutch plate 132 may be disposed axially between clutch plates 130, 142 and connected at an inner end to piston 128 and leaf springs 120, for example, via a connector such as a rivet. Leaf springs 120 allows axial displacement of piston 128 relative to front cover 104. Clutch plate 132 may be designed as a flexible clutch plate and referred to herein as flexible clutch plate 132. During the overbend process, clutch plate 132 is configured to move together and relative to piston 128, returning back to its working position after the riveting.

Piston 128 may be sealed to output hub 144 at an inner diameter thereof and configured to axially displace toward and away from front cover 104 to engage (close) and disengage (open) lock-up clutch 126. Clutch plate 130 may be disposed, at least partially, between front cover 104 and flexible clutch plate 132, and clutch plate 142 may be disposed between flexible clutch plate 132 and piston 128. Friction paper or rings may further be attached to front cover 104, clutch plate 130, flexible clutch plate 132, clutch plate 142 and/or piston 128. For example, friction materials (facings) may be attached to outer clutch plates 130, 142 and flexible clutch plate 132 may act as friction surface for the friction facings.

For the clutch release and apply function of lock-up clutch 126, clutch plate 132 is designed as a flexible clutch plate. That is, clutch plate 132 is bendable relative to piston 128, e.g., during operation of lock-up clutch 126. For example, clutch plate 132 may be formed from material such as 1074/1075 steel. The clutch plate 132 is designed to allow axial conformity between piston 128 and clutch plate 132. For example, holes may be provided in clutch plate 132, e.g., in various geometries, to reduce rigidity of the clutch plate 132 and thereby achieve a desired flexibility relative to piston 128. Additionally, or alternatively, a taper may be added to clutch plate 132, which can reduce or avoid undesirable drag torque during the release process of lock-up clutch 126.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 torque converter

102 central axis

104 front cover

106 impeller

108 impeller shell

110 impeller blade

112 impeller hub

114 turbine

116 turbine shell

118 turbine blade

120 leaf springs

122 stator

124 damper assembly

128 piston

130 clutch plate

132 clutch plate

134 one-way clutch

136 thrust bearing

138 thrust bearing

140 side plate

142 clutch plate

144 output hub

146 input cover plate

148 input cover plate

150 springs

152 output flange

What is claimed is:

1. A torque converter comprising:
a front cover configured to receive a torque;
an impeller having an impeller shell non-rotatably connected to the front cover;
a turbine fluidly coupled to the impeller and including a turbine shell; and
a lock-up clutch including:
a piston configured to axially displace to engage and disengage the lock-up clutch;
a first clutch plate and a second clutch connected to each other, the first and second clutch plates each being disposed between the piston and front cover; and
an intermediate clutch plate disposed between the first and the second clutch plates and connected to the piston.

2. The torque converter of claim 1, further comprising a leaf spring connected to the piston radially inside of the first and second clutch plates.

3. The torque converter of claim 2, wherein the intermediate clutch plate is connected to the leaf spring at a radially inner end thereof.

4. The torque converter of claim 2, wherein the leaf spring is, at least partially, disposed axially between the piston and the intermediate clutch plate.

5. The torque converter of claim 2, wherein the intermediate clutch plate, the leaf spring, and the piston are connected to each other via a riveted connection.

6. The torque converter of claim 1, wherein the intermediate clutch plate is connected to the piston radially inside of the first and second clutch plates.

7. The torque converter of claim 1, wherein the intermediate clutch plate is connected to the piston at a radially inner end thereof.

8. The torque converter of claim 1, wherein the first clutch plate is connected to the second clutch plate radially outside of the intermediate clutch.

9. The torque converter of claim 1, wherein the first clutch plate is connected to the second clutch plate radially outside of the piston.

10. The torque converter of claim 1, further comprising a damper assembly including an output flange and a cover plate disposed axially between the piston and the output flange, the first clutch plate being connected to the cover plate.

11. The torque converter of claim 1, wherein the intermediate clutch is configured to bend relative to the piston during operation of the lock-up clutch.

12. A lock-up clutch for a torque converter, comprising:
a piston configured to axially displace to engage and disengage the lock-up clutch;
a first clutch plate and a second clutch connected to each other; and
an intermediate clutch plate disposed between the first and the second clutch plates and connected to the piston.

13. The lock-up clutch of claim 12, further comprising a leaf spring connected to the piston radially inside of the first and second clutch plates.

14. The lock-up clutch of claim 13, wherein the intermediate clutch plate is connected to the leaf spring.

15. The lock-up clutch of claim 13, wherein the leaf spring is, at least partially, disposed axially between the piston and the intermediate clutch plate.

16. The lock-up clutch of claim 13, wherein the intermediate clutch plate, the leaf spring, and the piston are connected to each other via a riveted connection.

17. The lock-up clutch of claim 12, wherein the intermediate clutch plate is connected to the piston radially inside of the first and second clutch plates.

18. The lock-up clutch of claim 12, wherein the intermediate clutch plate is connected to the piston at a radially inner end thereof.

19. The lock-up clutch of claim 12, wherein the first clutch plate is connected to the second clutch plate radially outside of the intermediate clutch.

20. The lock-up clutch of claim 12, wherein the first clutch plate is connected to the second clutch plate radially outside of the piston.
